(19) United States
(12) Patent Application Publication
(10) Pub. No.: US 2010/0196610 A1
(43) Pub. Date: Aug. 5, 2010

(54) METHOD OF CONTAINER WITH HEAT INSULATING SURFACE LAYER

(76) Inventors: Sheng-Shu Chang, Taichung (TW); Hung-Ying Su, Taoyuan County (TW)

Correspondence Address: Dr. BANGER SHIA;Patent Office of Bang Shia, 102 Lindencrest Ct, Sugar Land, TX, 77479-5201, US

(21) Appl. No.: 12/602,123

(22) PCT Filed: May 27, 2007
(86) PCT No.: PCT/CN2007/001729

§ 371 Date: Nov. 27, 2009

(51) Int. Cl. B05D 3/02

(52) U.S. Cl. 427/379

(57) ABSTRACT

The present invention provides a method of manufacturing heat insulation container including the following steps: preparing a coating material by mixing a binder of polyurethane and a thermo-expandable powder, a weight of the thermo-expandable powder being 5-20% that of the binder; coating such coating material on a continuous paper reel or the paper-made or plastics-made container; drying the coated container to form a non-foaming surface for purposes of preservation; further heating the non-foaming surface under a heat temperature of 100-140 degrees Celsius to form a foaming layer on the outer surface so as to achieve heat insulation ability.

### BACKGROUND OF THE INVENTION

1. Field of the Invention

The present invention relates to a method for manufacturing a container, and more particularly to a method for manufacturing a heat insulation container.

2. Description of the Prior Art

A conventional container, in consideration of the cost and the purpose of popularization, is generally a paper-made or plastics-made container, such as a paper-made or plastics-made cup, bowl, and dish, or a filling container made of these materials, such as a packaging container, a heat preservation container and a lunch box.

Some conventional methods have been arisen to provide the container or the container semi-product with foaming layers, such as US 59522068 which uses Acrylic, and U.S. Pat. No. 6,265,040 which foams under a temperature of 65-100 degrees Celsius.

### SUMMARY OF THE INVENTION

The main object of the present invention is to provide a method for manufacturing a heat insulation container in order to resolve the following disadvantages:

(1) The paper-made container is provided with a single layer that cannot preserve and insulate heat. If the paper-made container is provided with double layer in folded means or with a partition, the cost is extremely high and the cost efficiency is not satisfying since the container is designed for one-time usage.

(2) The plastics-made container has only single layer without heat preservation effect.

(3) The paper-made or plastics-made container is merely printed to achieve aesthetic purposes, yet it does not have stereo patterns.

(4) For heat insulation purposes, the existing paper-made cup is held with an additional plastic cup supporter. However, the addition of the plastic cup supporter is in conflict to the original design intention of the one-time-usage paper-made cup since the cup supporter has to be recycled and stored after the paper-made cup is thrown.

(5) The acrylic has high glass transition temperature and is not sufficiently foamed at a low temperature. In addition, the container deforms at a high temperature, and the PE or PP coating layer is damaged.

(6) The acrylic with low glass transition temperature is normally sticky at room temperature. Thus the container semi-product coated with the same cannot be piled up, which leads to inventory problem. Another acrylic is designed to quickly soften at a predetermined temperature, yet it is very costly and will not be applied in such container manufacturing process.

(7) It takes longer time to foam the foaming material at 65-100 degrees Celsius. Such long-term heating process will cause the container to deform, damage and wet. Besides, the production efficiency is quite low.

To achieve the above and other objects, the present invention provides a solution as follows:

The present invention prepares a coating material by mixing a binder of polyurethane and a thermo-expandable powder, and then coats such coating material on a continuous paper reel or the paper-made or plastics-made container. The coated container and paper reel is then heated and dried so that the coating material is coagulated and adhered to the outer surface with the strength of the binder to form a non-foaming surface for purposes of preservation. The non-foaming surface is thereafter heated to form a foaming layer on the outer surface so as to achieve heat insulation ability.

The present invention may provide the paper-made container with stereo patterns with the help of a pattern mold, so as to elevate the aesthetic effect and heat insulation effect.

The thickness of the stereo patterns is determined by the coating thickness of the coating material and the heating temperature controlled within the range of 100-140 degrees Celsius. Also, the foaming procedure can be finished within a short time, resolving the disadvantages resulted from the long-term heating procedure.

The binder of polyurethane is an oleo-polyurethane so that it can be coagulated during the heating process.

The thermo-expandable power consists of a thermoplastic polymer shell and a low-boiling point solvent wrapped by the thermoplastic polymer shell, so that the foaming procedure can be finished with a short period of time without harming the paper-made of plastics-made product.

A weight of the thermo-expandable powder is 5-20% that of the binder.

In comparison with the conventional method, the present invention is advantageous in that the present invention provides a non-foaming surface for purposes of preservation. Thus the container with non-foaming surface can be easily stored and be further heated anytime to transfer the non-foaming surface into the foaming surface with heat insulation property.

### BRIEF DESCRIPTION OF THE DRAWINGS

FIG. 1 is a flow chart showing the method of the present invention;

FIG. 2 is a schematic drawing showing a roller device of the present invention;

FIG. 2-A is a plan view showing a container semi-product of the present invention after the drying process;

FIG. 2-B is a perspective drawing showing a container of the present invention after the drying process;

FIG. 2-C is a perspective drawing showing a container of the present invention after the drying process;

FIG. 3-A is a perspective drawing showing a container of the present invention after the foaming process;

FIG. 3-B is a perspective drawing showing a container of the present invention after the foaming process;

FIG. 3-C is a perspective drawing showing a container of the present invention after the foaming process;

FIG. 4-A is a profile showing a container of the present invention after the foaming process;

FIG. 4-B is a profile showing a container of the present invention after the foaming process.

### DETAILED DESCRIPTION OF THE PREFERRED EMBODIMENTS

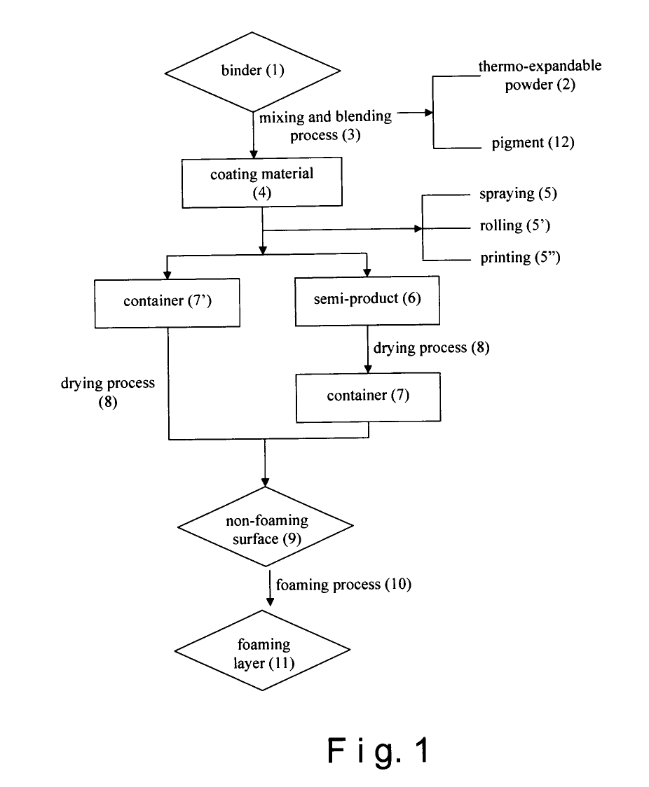

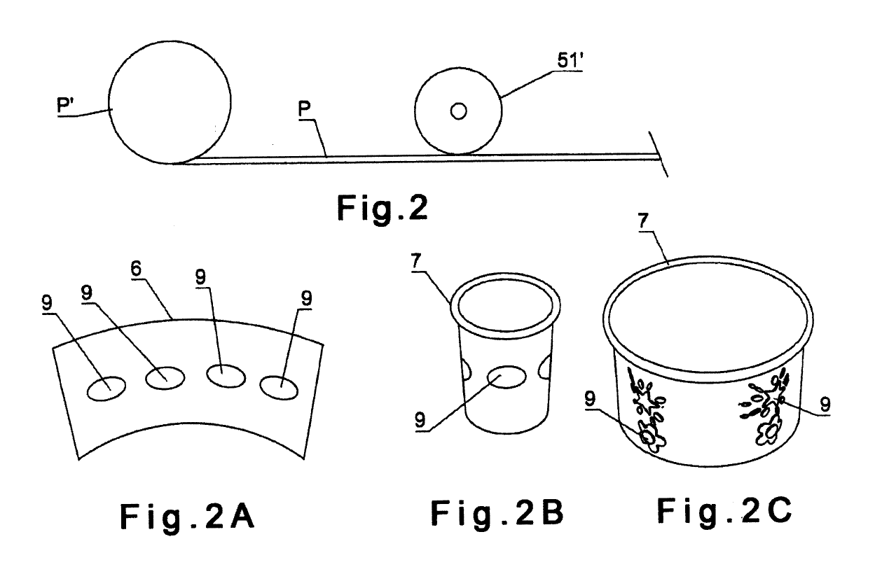

Please refer to FIG. 1. A method of the present invention includes preparing a coating material 4 by a mixing and blending process 3 including mixing and blending a binder 1 of polyurethane and a thermo-expandable powder 2. The coating material 4 is coated on an outer surface of a semi-product 6 (as shown in FIG. 2-A) or of a paper-made container 7′ (as shown in FIGS. 2-B and 2-C). The semi-product 6 may be further formed into a container 7. The container 7, 7′ undergoes a drying process 8 by heating and drying the container 7, 7′ below a foaming temperature of the thermo-expandable powder. As such, the coating material is adhered to the outer surface of the paper reel, the paper-made container or the plastics-made container to form a non-foaming surface 9 without stickiness for purposes of preservation. The non-foaming surface 9 can be thereafter further heated and undergoes a foaming process 10 to make the thermo-expandable powder 2 start foaming to form a foaming layer 11, so as to achieve heat insulation effect.

The polyurethane binder 1 may be an oleo-polyurethane. Therefore, it is still coagulated during the foaming process. Also, it is not sticky at room temperature.

The thermo-expandable powder 2 consists of a thermoplastic polymer shell and a low-boiling-point solvent wrapped by the thermoplastic polymer shell.

A weight of the thermo-expandable powder 2 is 5-20% that of the binder 1. The coating material expands four times its original volume after the foaming process.

Please refer to FIG. 1 and FIG. 2. The roller 51′ of the rolling device 5′ for the coating material 4 may be provided with a pattern mold, so that the coating material 4 can be continuously printed on a paper P of a paper reel P′ and then undergoes the drying process 8 below the foaming temperature. Thereafter the paper P is cut into semi-product 6 (as shown in FIG. 2-A) which can be further formed into the container 7. Or, the container may be preformed and then undergoes the drying process 8 below the foaming temperature. As such, the non-foaming surface 9 (as shown in FIG. 2-A to FIG. 2-C) is formed on the outer surface of the container. Thereafter, the non-foaming surface 9 undergoes the foaming process 10 under a heating temperature of 100-140 degrees Celsius based on a material of the foaming surface to form a protrusive foaming layer on the outer surface. The protrusive foaming layer is adapted to be held to provide heat insulation and aesthetic effect.

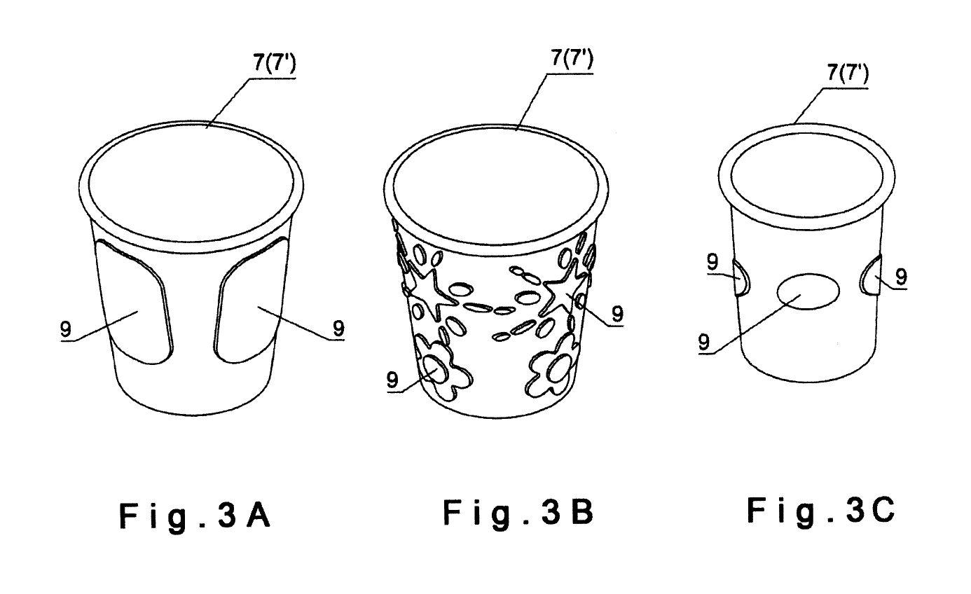

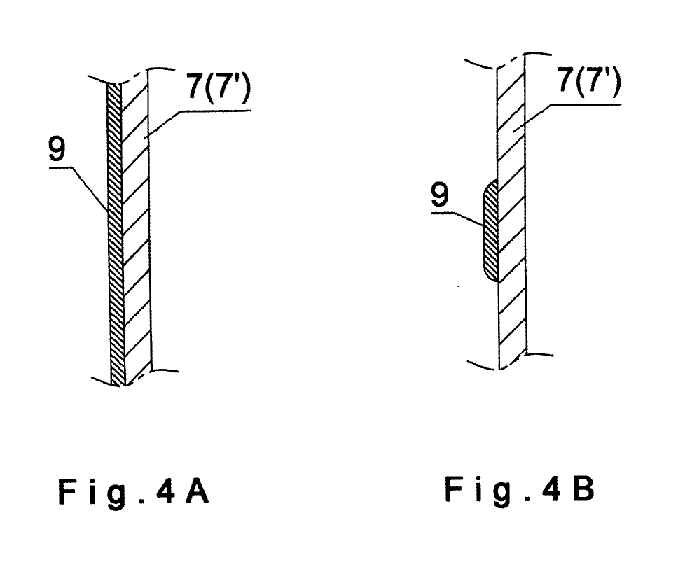

Please refer to FIG. 1, FIG. 2-A to FIGS. 2-C, FIG. 3-A to FIG. 3-C and FIG. 4-A to FIG. 4-B, the coating material 4 can be partially coated anywhere adapted to be held on the container 7 (7′) without fully coating. When molding the container, the coating material 4 is coated on the surface of the container 7 (7′) and dried to form a non-foaming surface 9 on the outer surface of the semi-product 6 or the container 7 (7′) for the preservation purposes.

Please refer to FIG. 1, FIG. 3-A to FIG. 3-C and FIG. 4A to FIG. 4-B. The coating material may be further mixed with a pigment 12 so as to form a colored foaming pattern. Or, the partially coated non-foaming surface 9, as shown in FIG. 4-B, or the fully coated non-foaming surface 9, as shown in FIG. 4-A, of the container 7 (7′) may be tinted in a manner of spraying, printing 5″ or rolling and then undergoes the foaming process 10 to form a colored foaming layer 11.

The thickness of the stereo patterns is determined by the heating temperature controlled with the range of 100-140 degrees Celsius.

The previous embodiments is shown for descriptive purposes only, and it should includes a variety of paper-made or plastics-made containers, such as cup, bowl, dish, lunch box and packaging container with heat insulation property and preservation convenience.

What is claimed is:

1. A method for manufacturing a heat insulation container, characterized in that the method comprising:
(a) preparing a coating material by mixing and blending a binder of polyurethane and a thermo-expandable powder consisting of a thermoplastic polymer shell and a low-boiling-point solvent wrapped by the thermoplastic polymer shell, a weight of the thermo-expandable powder being 5-20% that of the binder;
(b) coating the coating material on an outer surface of a container or a container semi-product made of paper or plastics;
(c) heating and drying the container or the container semi-product below a foaming temperature of the thermo-expandable powder, so that the coating material being coagulated and adhered to the outer surface with the strength of the binder to form a non-foaming surface without stickiness for purposes of preservation;
(d) further heating the non-foaming surface under a heating temperature of 100-140 degrees Celsius based on the foaming material to form a protrusive foaming layer on the outer surface.

2. The method of claim 1, characterized in that the non-foaming layer is tinted in a manner of spraying, printing or rolling before being further heated.
